(19) United States
(12) Patent Application Publication
(10) Pub. No.: US 2003/0027605 A1
(43) Pub. Date: Feb. 6, 2003

(54) Mobile wireless terminal device capable of informing with varied contents for ringing

(75) Inventor: Kazuyoshi Hijii, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/200,485

(22) Filed: Jul. 23, 2002

(30) Foreign Application Priority Data
Aug. 6, 2001 (JP) 238041/2001

(51) Int. Cl. H04M 3/42; H04M 1/00; H04B 1/38

(52) U.S. Cl. 455/567; 455/415; 455/414

(57) ABSTRACT

A mobile wireless terminal device comprising a speech codec circuit, a channel codec circuit, a modulator/demodulator circuit and a radio circuit, which is connected to a base station by radio. A ROM (or RAM) stores a plurality of telephone tone data having different contents. The telephone tone data is read from the ROM (or RAM) in an order that has been set in advance when a call is received. The data is converted into sound and the speech codec circuit outputs the sounds from a speaker. The plurality of telephone tone data reflects the intentions of the user, thus ensuring the user to know whether his device or other's device is receiving a call.

### BACKGROUND OF THE INVENTION

1. Field of the Invention

The present invention relates to a mobile wireless terminal device, and, more particularly, to a mobile wireless terminal device capable of indicating an incoming call with varied sounds. The user arranges inherent voices and melodies to be used as telephone tones when receiving a call.

2. Description of the Related Art

Typically, mobile wireless terminal devices, such as mobile telephones or PHS (Personal Handy-phone System) telephones, produce sound melodies that have been selected in advance, or original telephone tones when a call is received so as to let the user know the receipt of the call. There is a plurality of melodies or telephone tones available.

Recently, the number of mobile telephones has grown to surpass that of conventional telephones and the number of subscribers is still expected to increase. Under these circumstances, it will be normal that there could be other persons around who have the telephones of the same type and of the same manufacture. In such a case, if other persons use the same telephone tone, one may not be able to know whether telephone of the other persons or his telephone is receiving a call.

In order to solve such a problem, there have been a variety of proposals. For example, in Japanese Laid-Open Patent Application Heisei 11-32105, information that corresponds to the telephone number of that caller is recalled from a storage device and voice information such as “Telephone call from Mr. Mike” is output from a speaker, so that the caller is easily identified. In Japanese Laid-Open Patent Application 2000-278395, sounds corresponding to each number comprising the incoming telephone number of a caller are output from a speaker as “zero”, “three”, “three” . . . Thus, the caller can be identified by sound, even when the display backlight is broken or the mobile telephone is placed in a bag.

In Japanese Laid-Open Patent Application 2001-53832, different score data using different tones can be reproduced as acoustic signals. The plural different acoustic signals are synthesized to produce one tune as a telephone tone, so that the telephone tone melody from one's mobile wireless terminal device can be distinguished from that other mobile wireless terminal devices. In Japanese Laid-Open Patent Application 2001-53839, the display backlight is driven in a flashing pattern that corresponds to the incoming telephone number of a caller. Thus, the user can recognize the digital tone even under conditions where he can not hear the telephone tone.

However, Japanese Laid-Open Patent Application Heisei 11-32105 and Japanese Laid-Open Patent Application 2000-278395 show conventional generalized methods of using speech to indicate the receipt of an incoming call. This makes it impossible to make a distinction between one's mobile wireless terminal device and mobile wireless terminal devices of other persons when they are of the same type or follow the same trend. Japanese Laid-Open Patent Application 2001-53832, requires a certain degree of knowledge of music to formulate a telephone tone from the score data using different tones. It is assumed that the majority of users are not able to handle this, and a more complicated configuration is required. Moreover, Japanese Laid-Open Patent Application 2001-53839 is effective only under conditions where the user can see the flashing. In any of these cases, the telephone tone is confined to one kind of message or melody for ringing. This provides information too insufficient to know whether one's device or others' device is receiving a call, thus leaving the uncertainty in distinguishing one from the other.

### SUMMARY OF THE INVENTION

An aspect of the present invention is to provide a mobile wireless terminal device that ensures the user to know whether his device or others' device is receiving a call.

To solve the above mentioned problem, a mobile wireless terminal device of the present invention comprises a receiving means for receiving a call, and a storing means for storing information corresponding to a telephone tone. The mobile wireless terminal further comprises an informing means that informs a user of a received call by ringing different telephone tones in a predetermined order. The user can set the predetermined order in advance. The mobile communication terminal device of the present invention further comprises a setting means that sets a waiting period between the ringing operations. The waiting period can be changed according to the number of ringing times. The user can set the waiting period in advance. The telephone tone is preferably voice data or melody data. The voice data may be at least one of digitized data of recorded voice of the user and voice-synthesized data. The melody data can be downloaded melody data.

Further, a mobile wireless terminal device of the present invention comprises a receiver that receives a call, a memory that stores information regarding a telephone tone and an indication circuit that informs a user of a received call by ringing different telephone tones in a predetermined order. The user can set the predetermined order in advance. The mobile communication terminal device of the present invention further comprises a setting circuit that sets waiting period between the ringing operations. The waiting period can be changed according to the number of times of ringing. The user can set the waiting period in advance. The telephone tone is preferably voice data or melody data. The voice data could be at least one of digitized data of the recorded voice of the user and voice-synthesized data, and the melody data can be downloaded musical data.

A call informing method for a mobile communication terminal device of the present invention comprises storing information regarding a predetermined order of ringing a plurality of telephone tones, and receiving a call. The method further comprises outputting first telephone tone by reference to the information for informing a user of a received call and outputting second telephone tone that is different from the first telephone tone by reference to the information for informing a user of a received call. The method further comprises generating a first waiting period between the first telephone tone and the second telephone tone. The method further comprises generating a second waiting period after the second telephone tone. The first waiting period can be different in duration from the second waiting period. The telephone tone is preferably voice data or melody data. The voice data may be at least one of digitized data of the recorded voice of the user and voice-synthesized data, and the melody data could be downloaded musical data.

The mobile wireless terminal device according to this invention comprises storage means for storing a plurality of telephone tone data having different contents. The mobile wireless terminal device further comprises a control means for reading, in response to a received call, the telephone tone data from the storage means in a predetermined order set in advance and outputting the data as sound. Informing the user of a received call with different sounds for each ringing operation provides variations in ringing sounds and allows the user to recognize that the telephone tone is the one that the user himself has set in advance. It further ensures the user to know whether his device or other's device is receiving a call. In particular, the recognition will be much more certain when the voice of the user is used.

### BRIEF DESCRIPTION OF THE DRAWINGS

These and other aspects, features and advantages of the invention will become more fully apparent from the following detailed description taken in conjunction with accompanying drawings. In the drawings:

FIG. 1 is a block diagram showing an embodiment of the mobile wireless terminal device according to the present invention.;

FIG. 2 shows an example of a combination of telephone tones up to the fourth time of ringing;

FIG. 3 shows an example in which speeches are used for the telephone tones;

FIG. 4 is an explanatory diagram showing the storage format of the telephone tone stored in the ROM or RAM of FIG. 1; and

FIG. 5 is a flowchart showing the operation of the mobile wireless terminal device according to the present invention.

### DETAILED DESCRIPTION OF THE EMBODIMENTS

Hereinafter, each embodiment of the present invention will be described in detail with reference to the drawings.

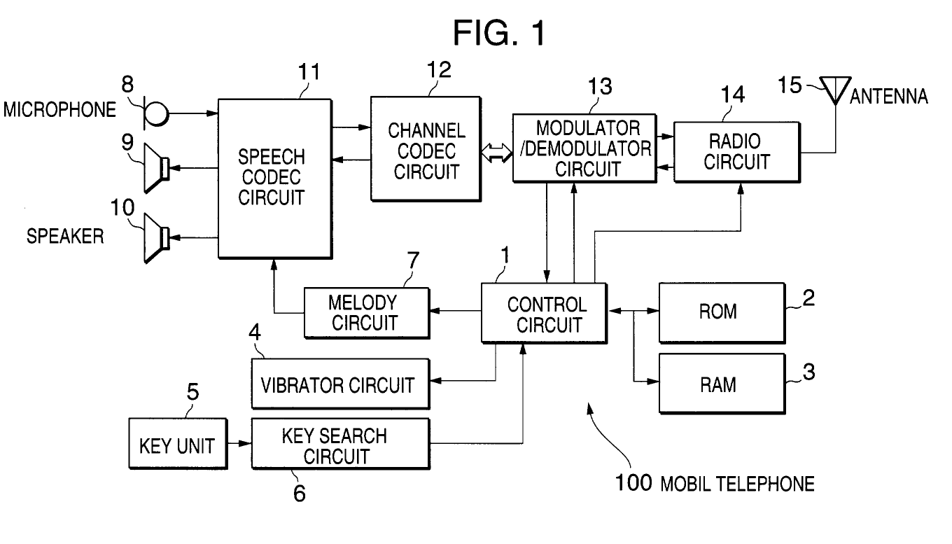

FIG. 1 shows an embodiment of the mobile wireless terminal device according to the present invention.

In this embodiment, a mobile telephone is used as the mobile wireless terminal device. A mobile telephone 100 as the mobile wireless terminal device comprises a control circuit 1 for controlling the mobile telephone 100, a ROM 2 (e.g., flash memory) for storing a program to operate the mobile telephone 100 and telephone tone data and a RAM 3 for temporarily storing data. The mobile telephone 100 further comprises a vibrator circuit 4 connected to the control circuit 1 for informing a user of a received call by the vibration of a vibrator (not shown) according to the presetting. The mobile telephone 100 further comprises a key unit 5 having number keys and symbol keys for inputting data such as telephone numbers, and a key search circuit 6 for detecting the operating of the key circuit 5. The mobile telephone 100 further comprises a melody circuit 7 for outputting the telephone tone read from the memory at the time when a call is received. The mobile telephone 100 further comprises a microphone (a transmitter) 8, a receiver 9, and a speaker 10 (for indicating received call informing). The mobile telephone 100 further comprises a speech codec circuit 11, a channel codec circuit 12, a modulator/demodulator circuit 13, a radio circuit 14 for generating transmitting signals and receiving signals, and an antenna 15 attached to a device body (not shown) for emitting and receiving signals.

The RAM 3 stores the state of the mobile telephone 100 (backup when its electric source is turned off), and data on such as voices or melodies that have been downloaded or recorded. Voice recording is possible by collecting voice from the microphone 8 and the receiver 9 or the speaker 10 can reproduce the voice. The speech codec circuit 11 digitizes voice signals from the microphone 8 and converts digitized voice signals from the channel codec circuit 12 into an analog form in order to reproduce them. The channel codec 12 applies such as TDMA/TDD (Time Division Multiplex Access/Time Division Duplex) processing to transmitted and received signals to generate a transmitted frame, and applies a series of processing to demodulated signals reproduced by the modulator/demodulator circuit 13 to produce digital sound information. The modulator/demodulator circuit 13 modulates the voice information from the speech codec circuit 11 by QPSK (quadrature phase shift keying) to generate baseband signals, and demodulates QPSK modulated signals from the radio circuit 14.

The general operation of the mobile telephone 100 will now be described. When a call comes from a base station to the mobile telephone 100, the antenna 15 receives the signal and the radio circuit 14 amplifies the signal. The received signal is applied to the modulator/demodulator circuit 13. The modulator/demodulator circuit 13 demodulates the signal, and the channel codec circuit 12 decodes demodulated signal. The decoded digital signal is applied to the control circuit 1 and the channel codec circuit 12. The control circuit 1 detects the received call from the signal coming from the modulator/demodulator circuit 13 and reads preset telephone tone signals from the ROM 2 (or RAM 3). The signals are combined into a telephone tone in the melody circuit 7, and the speech codec circuit 1 converts the telephone tone into analog signals to be output as a telephone tone from the speaker 10.

When the user hears the telephone tone and answers the call (off-hook), it is connected with the transmitting source and a conversation is started. At this time, the modulator/demodulator circuit 13 demodulates the received voice of the other party, and the channel codec circuit 12 decodes the demodulated voice signal. The speech codec circuit 11 converts the decoded speech signal into an analog signal to be output as a received voice from the receiver 9. The microphone 8 converts the voice of the user of the mobile telephone 100 into an electric signal and the speech codec circuit 11 digitizes the electric signal. The channel codec circuit 12 encodes the electric signal, and the modulator/demodulator circuit 13 QPSK-modulates the encoded electric signal. The radio circuit 14 coverts and power-amplifies the encoded electric signal into a transmission signal, and the antenna 15 transmits the amplified signal towards the base station.

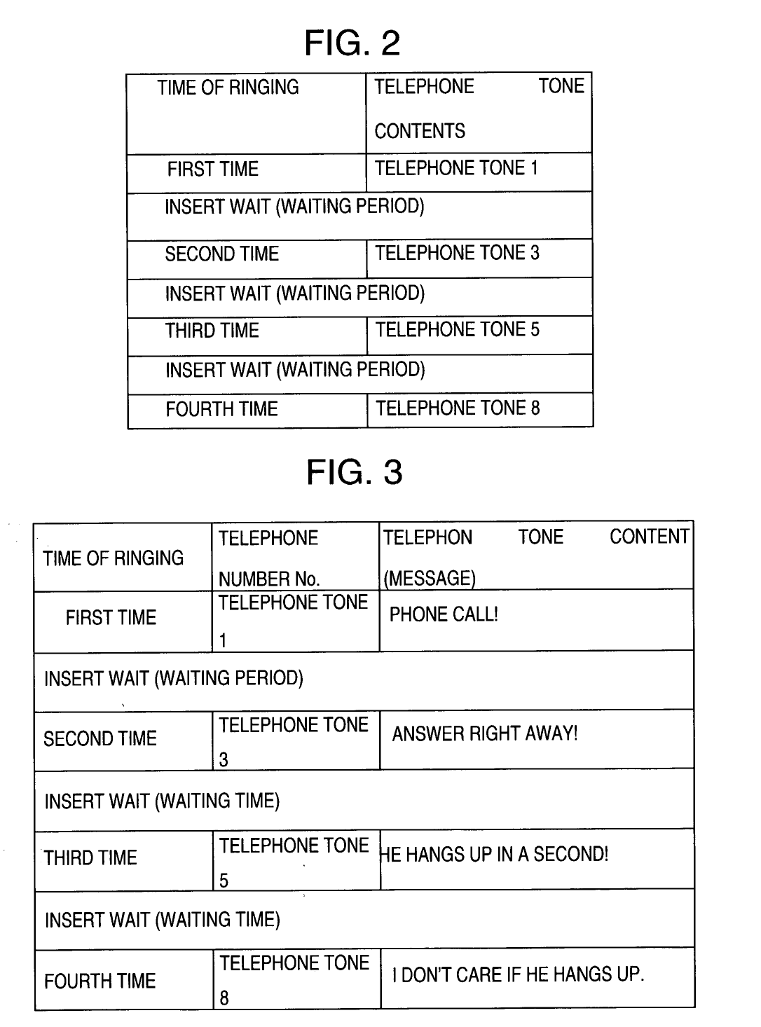

In conventional mobile telephones, the telephone tone setting is confined to setting for only one kind of telephone tone (one tune) regardless of the caller. This provides information that is too insufficient to distinguish one caller from the other. The present invention enables a plurality of telephone tones to be selected and their order to be selected at the time of setting. When receiving a call, telephone ringing continues until the recipient puts the telephone in an off-hook state while each time of ringing is separated at certain intervals, except when the telephone is in an answering state. An example of a combination of telephone tones up to the fourth time of ringing is illustrated in FIG. 2.

In a first received call, different telephone tones are selected for each of first, second, third and fourth ringing. In an example of FIG. 2, four telephone tones “telephone tone 1”, “telephone tone 3”, “telephone tone 5” and “telephone tone 8” are selected. The user can select any telephone tones from those stored in the ROM 2 or the RAM 3. Here, although the telephone tones “1”, “3”, “5” and “8” are applied, four other numbers of telephone tones can be selected depending on the way of indicating a received call. Moreover, there may be four or more times of ringing, and the telephone tones can be allocated to each time. Different kinds of melodies or digital tones (e.g., beep or peep) may be used. Voices that the user has recorded in advance through the microphone 8 and the speech codec circuit 11 may also be used.

As shown in FIG. 2, between the first “telephone tone 1” and the second “telephone tone 3”, between the second “telephone tone 3” and the third “telephone tone 5”, and between the third “telephone tone 5” and the fourth “telephone tone 8”, “waits” are inserted. The “wait” represents a waiting period, which is a period of time until the next time of ringing starts. The three waiting periods may be equal or different. For example, the third one may be set to be longer than the second one. The user can freely set and change the “wait” periods by using the key unit 5. Set as in FIG. 2, when a signal (call) is received, the telephone tones sound (sound output) from the speaker 10, which is for indicating a received call informing, in the order “telephone tone 1”→“wait”→“telephone tone 3”→“wait”→“telephone tone 5”→“wait”→“telephone tone 8”.

FIG. 3 shows an example in which speeches are used for the telephone tones. Here, each of the telephone tones contains the recorded contents as follows:

“telephone tone 1”=“I don't care if he hangs up.”

“telephone tone 3”=“Phone call!”

“telephone tone 5”=“Answer right away!”

“telephone tone 8”=“He hangs up in a second!”

In a combination shown in FIG. 3, when a call is received, messages are output from the speaker 10 in the order “Phone call!”→“Answer right away!”→“He hangs up in a second!”→“I don't care if he hangs up”. In this way, using speeches as the telephone tone enables the user to quickly recognize that it is his mobile telephone that is receiving a call, rather than in the case where melodies or consecutively repeated sounds are used. Using the recorded voice of the user himself will further ensure the user to distinguish the telephone tone.

In order to make a telephone tone by recording, the user selects a telephone tone making mode, and operates the keys on the key unit 5 according to the guidance displayed on the display unit. When the user speaks what he would like to be recorded at the speaker, the recording takes place. After this, by repeating the key operating process on the key unit 5 in accordance with the displayed guidance for necessary number of times, the telephone tone will be completed.

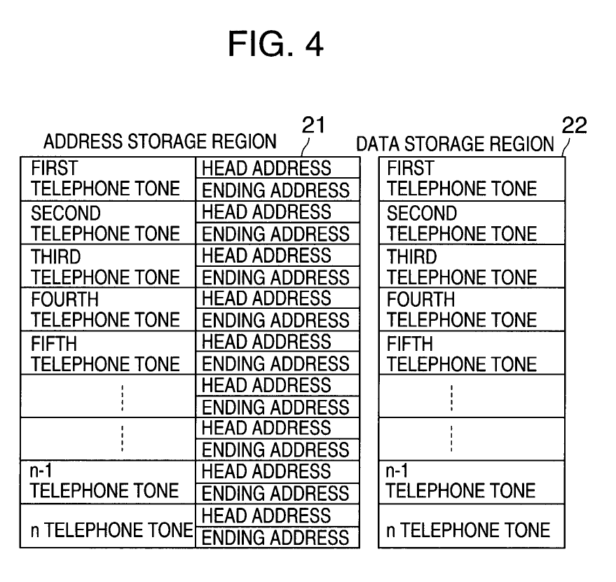

FIG. 4 shows a storage format of the telephone tone stored in the ROM 2 or RAM 3. The telephone tone is stored in the ROM 2 (or the RAM 3) in the format shown in FIG. 4. The telephone tone is stored using an address storage region 21 and a data storage region 22. The address storage region 21 stores starting addresses and ending addresses that correspond to the respective first telephone tone to n telephone tone. The data storage region stores actual telephone tone data of the first telephone tone to n telephone tone. Addresses written in the address storage region 22 are linked with addresses at which the data is stored.

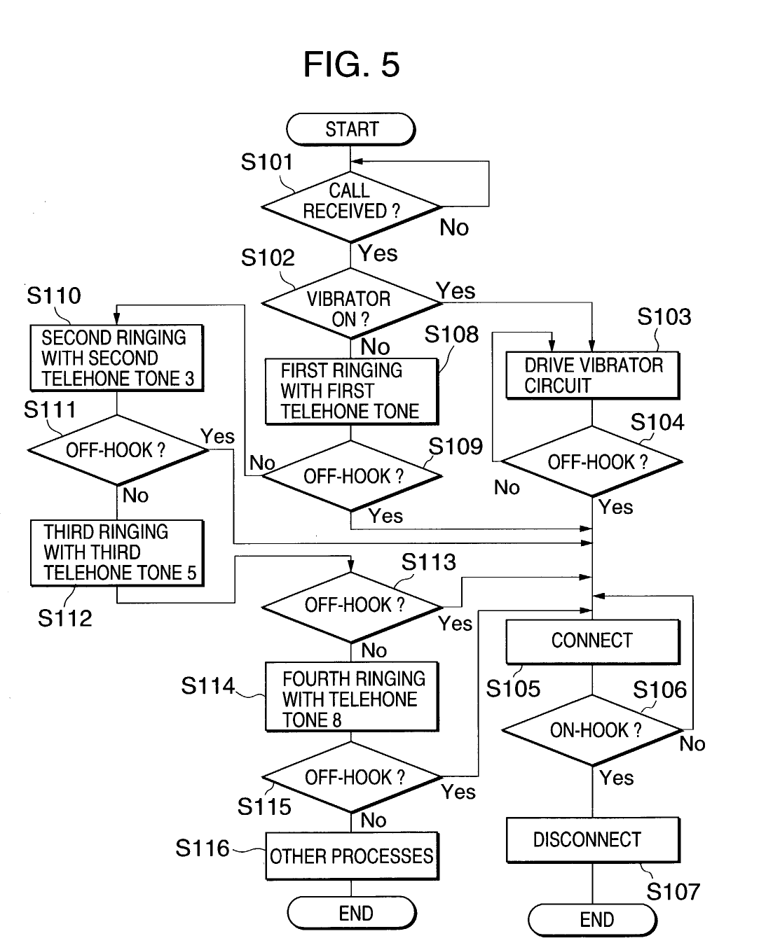

FIG. 5 shows an embodiment of the call processing according to the present invention. Operation of the mobile wireless terminal device according to the invention will be described with reference to FIG. 1 to FIG. 5.

When a signal (call) is received by the mobile telephone (S101), it judges whether or not the manner mode (vibrator function) is turned on (S102). If it is turned on, the control circuit 1 drives the vibrator circuit 4 to operate the vibrator (S103). Having sensed the operating of the vibrator, the user presses a start button on the key unit 5 (S104), and the line is connected (S105), and communication can be started. After the communication has finished, the user presses a finish button on the key unit 5 (S106) and the line is disconnected (S107).

On the other hand, if the manner mode is turned off in S102, a first ringing operation with the first telephone tone will be started. Here, it is assumed that each of telephone tone 1, telephone tone 3, telephone tone 5, and telephone tone 8 shown in FIG. 2 corresponds to each of first telephone tone, third telephone tone, fifth telephone tone, and eighth telephone tone in the address storage region 21 of FIG. 4.

As shown in FIG. 4, data is read from the head address of the first telephone tone (telephone tone 1) that has been set in the address storage region 21 of the ROM 2, and the first telephone tone sounds for a certain period of time (waiting period) (S108). It is read from the head address and combined into a melody by the melody circuit 7 and processed into an analog sound output by the speech codec circuit 11 to be output from the speaker 10 as the first telephone tone.

Having heard the telephone tone, the user presses the start button for the off-hook state, and the mobile telephone is connected to the base station (S105), and then communication is started. After the communication has finished, if the on-hook state is detected (S106), the telephone is disconnected from the base station (S107) and the communication process is terminated. When there has not been an off-hook operation in the first ringing operation, the telephone tone 3, which is the second telephone tone, is read from its head address to its ending address in the data storage region 22. After passing through the melody circuit 7 and the speech codec circuit 11, the telephone tone 3 is output as the second telephone tone from the speaker 10 and the second ringing operation is made (S110). Contrary to this, when the off-hook state is made by the press of the start button (S111), the mobile telephone is connected to the base station (S105), and communication is started. When the off-hook state has not been detected in S 111, the next ringing operation with the telephone tone 5 takes place in the same procedure as the above (S112). When no response is made to the ringing (S113), the next ringing operation with the telephone tone 8 takes place in the same procedure as the above (S114). When there is a response (off-hook) to the ringing of the telephone tone 5 or the telephone tone 8 (S113 or S115), the processes after S105 are executed, that is, a connecting process (S105) and a disconnecting process (S107). When the off-hook state has not been detected in S115, which means that the set number of times of ringing has finished, other processes such as call receipt logging process, transferring process or answering process are executed (S116).

As described, according to the embodiment of the present invention, every time the telephone tone is turned on, varied contents can be output from the speaker 10. By making the telephone tone as a message and using the voice of the user, the mobile telephone outputs a telephone tone that makes it as if it is speaking. This ensures the user to know whether his mobile telephone or another person's mobile telephone is receiving a call. It is therefore not necessary to take the mobile telephone out of a bag and such to look at its display unit or its receiving lamp (LED) for confirmation.

In the above embodiment, by a setting caller's name in the process of selecting in such a way as “first telephone tone, second telephone tone, . . . ”, its address can be retrieved from “callers' telephone numbers”, so that the user, who is the recipient, can be informed by sound as a telephone tone of “caller's name” that corresponds to the address. In this case, the telephone tone can be made by recording the caller's names in advance or by combining the pronunciations such as “a”, “i”, “u” to constitute a name.

Furthermore, when the “caller's name” has been registered in the address book, a telephone tone as “from Mr. Mike” can be made. When the “caller's name” is not registered in the address book, a telephone tone as “from a stranger” can be made.

Obviously, numerous additional modifications and variations of the present invention are possible in light of the above teachings. It is, therefore, to be understood that within the scope of the appended claims, the invention may be practiced otherwise than as specifically described herein.

What is claimed is:

1. A mobile communication terminal device comprising:
receiving means for receiving a call;
storing means for storing information corresponding to a telephone tone; and
informing means that informs a user of an incoming call by ringing a plurality of different telephone tones in a predetermined order in response to said received call.

2. The mobile communication terminal device as claimed in claim 1, wherein said information can be set by said user in advance.

3. The mobile communication terminal device as claimed in claim 2, further comprising setting means for setting a waiting period between the ringing of the different telephone tones of said plurality of different telephone tones.

4. The mobile communication terminal device as claimed in claim 3, wherein said waiting period can be changed according to the number of ringing times.

5. The mobile communication terminal device as claimed in claim 4, wherein said waiting period can be set by said user in advance.

6. The mobile communication terminal device as claimed in claim 5, wherein said telephone tone is at least one of voice data and melody data.

7. The mobile communication terminal device as claimed in claim 6, wherein said voice data is at least one of digitized data of the recorded voice of said user and voice-synthesized data.

8. The mobile communication terminal device as claimed in claim 6, wherein said melody data is downloaded data.

9. A mobile communication terminal device comprising:
a receiver that receives a call;
a memory that stores information corresponding a telephone tone; and
an indication circuit that that indicates an incoming call to a user by ringing a plurality of different telephone tones in a predetermined order in response to said received call.

10. The mobile communication terminal device as claimed in claim 9, wherein said information can be set by said user in advance.

11. The mobile communication terminal device as claimed in claim 10, further comprising a setting circuit for setting a waiting period between the ringing of the different telephone tones of said plurality of different telephone tones.

12. The mobile communication terminal device as claimed in claim 11, wherein said waiting period can be changed according to the number of ringing times.

13. The mobile communication terminal device as claimed in claim 12, wherein said waiting period can be set by said user in advance.

14. The mobile communication terminal device as claimed in claim 13, wherein said telephone tone is at least one of voice data and melody data.

15. The mobile communication terminal device as claimed in claim 14, wherein said voice data is at least one of digitized data of the recorded voice of said user and voice-synthesized data.

16. The mobile communication terminal device as claimed in claim 14, wherein said melody data is downloaded data.

17. A call informing method for a mobile communication terminal device comprising:
storing information corresponding a plurality of telephone tones, said information listing a predetermined order for ringing said plurality of telephone tones;
receiving a call;
outputting first telephone tone by referring to said information for informing a user of a received call; and
outputting second telephone tone that is different from said first telephone tone by referring to said information for informing a user of a received call.

18. The call informing method for said mobile communication terminal device as claimed in claim 17, further comprising generating a first waiting period between said first telephone tone and said second telephone tone.

19. The call informing method for said mobile communication terminal device as claimed in claim 18, further comprising generating a second waiting period after said second telephone tone.

20. The call informing method for said mobile communication terminal device as claimed in claim 19, wherein said first waiting period is different from said second waiting period.

21. The call informing method for said mobile communication terminal device as claimed in claim 20, wherein said telephone tone is at least one of voice data and melody data.

22. The call informing method for said mobile communication terminal device as claimed in claim 21, wherein said voice data is at least one of digitized data of the recorded voice of said user and voice-synthesized data.

23. The mobile communication terminal device as claimed in claim 21, wherein said melody data is downloaded data.
